(19) United States
(12) Patent Application Publication
(10) Pub. No.: US 2014/0047672 A1
(43) Pub. Date: Feb. 20, 2014

(54) HINGE DEVICE

(71) Applicants: Makoto Saito, Aikawa-machi (JP); Takao Kobayashi, Aikawa-machi (JP)

(72) Inventors: Makoto Saito, Aikawa-machi (JP); Takao Kobayashi, Aikawa-machi (JP)

(21) Appl. No.: 14/000,057

(22) PCT Filed: Feb. 13, 2012
(86) PCT No.: PCT/JP2012/053310

§ 371 Date: Oct. 29, 2013

(30) Foreign Application Priority Data
Feb. 17, 2011 (JP) 2011-031826

(51) Int. Cl. G06F 1/16

(52) U.S. Cl. CPC G06F 1/1681
USPC 16/341

(57) ABSTRACT

Provided is a hinge device which, both before and after the change of friction torque, maintains the friction torque, and is prevented from axial lengthening. A shaft member is rotatably supported by a stationary-side bracket, a cam member is axially movable, with its rotation being restricted by the shaft member, a biasing element applies a bias in the direction toward the place where the cam member and the bracket contact each other to generate friction torque, and a convex portion and a concave portion are formed on the cam member and the bracket, respectively, to be fitted to each other. Either the convex portion and/or the concave portion is/are shaped such that the torque changes according to the rotation angle of the shaft member, and the biasing element has the inflection point of a spring constant between the maximum and minimum values of the torque.

### TECHNICAL FIELD

The present invention relates to a hinge device that is built into a notebook computer, a mobile phone, an on-vehicle monitor, or the like, and wherein the hinge device, for example, pivotally connects the lid of a main body to allow the lid to open and close relative to the main body.

### BACKGROUND ART

FIG. 14 shows an example of a notebook computer 100. In that figure, the main body (a keyboard) is referred to as a first member 110, and the cover (a display) is referred to as a second member 120 that is mounted to the first member 110 so as to be able to be opened and closed. The opening and closing of the second member 120 is made by rotating the second member 120 relative to the first member 110. In order that the second member 120 to the first member 110, These members 110 and 120 are connected together by a hinge device 130 so as to be pivotally connected.

FIG. 15 illustrates the characteristic features of the aforesaid notebook computer 100, in which the second member 120, consisting of a display, must be able to be maintained at any specified angle within the predetermined range of angles (20°-160°). Also, the second member 120 must be able to automatically close if it is open at an angle of 0°-20° in relation to the first member 110.

FIG. 16 shows a prior-art hinge device 1 referred to in WO2006/35757 and Japanese Patent No. 4528468, which disclose a structure providing variable torque that allows the second member 120 to be maintained at any specified angle. FIG. 16 shows the state of the hinge device when the second member 120 is closed (at an angle of 0° relative to the first member 110).

The hinge device 1 includes a shaft member 2 that is fixed to the second member 120 by a screw 7, and a bracket 3 that is fixed to the first member 110 by a screw 8. In the hinge device 1, a cam member 5 is fixed to the shaft member 2.

As shown in FIG. 17, the bracket 3 is formed by a flat flange 31 on the bottom of the bracket 3, and a bearing 32 that extends upward from the flange 31. The flange 31 is fixed to the first member 110 by a screw 8. Accordingly, the bracket 3 is a part of an immobilized member. When the bracket 3 is immobilized by fixing the flange 31 to the first member 110 by a screw 8, the flange 31 becomes horizontal as shown in FIG. 17, and in such a condition, the bearing 32 extends upward from the first member 110 (When the bracket 3 is not immobilized like that, the bearing 32 is not extending upward). The bearing 32 is provided with a round axial hole 33, through which the axial body 22 of the shaft member 2 rotatably penetrates.

As shown in FIG. 16, the shaft member 2 is formed of a shaft main body 21 and the axial body 22 that integrally extends from one side of the shaft main body 21, which is fixed to the second member 120 by the screw 7. Accordingly, if the second member 120 is rotated, the shaft member 2 integrally revolves with the second member 120. The axial body 22 has a non-circular shape formed as if it has been cut from a circular body in such a way that the axial body 22 has two sides that are parallel to each other. However, the axial body 22 can have any of a variety of shapes other than a circular shape, including a D shape, a rectangular shape, an elliptical shape, and so on.

The cam member 5, which has a circular shape as shown in FIG. 18, is sandwiched between the bearing 32 of the bracket 3 and a biasing means 6. The cam member 5 is provided with a non-circular axial hole 53 whose shape corresponds to that of the axial body 22 of the shaft member 2, and the axial body 22 penetrates through the axial hole 53, whereby the cam member 5 is connected to the shaft member 2 so as to be integrally rotatable with the shaft member 2. Accordingly, the cam member 5 is a rotational member, whereby the rotation of the second member 120 causes the cam member 5 to integrally rotate with the shaft member 2. During this rotation, the cam member 5 and the bracket 3 contact each other, which generates friction torque between them.

The biasing means 6 is formed by laminating multiple leaf springs 61 in the lengthwise direction of the axial body 22 of the shaft member 2. Each leaf spring 61 is provided with a circular axial hole through which the axial body 22 penetrates, whereby the shaft member 2 rotatably penetrates the biasing means 6. In the hinge device 1 of FIG. 16, the biasing means 6 is formed by laminating three leaf springs 61, each of which has the same spring constant.

In FIG. 16, the reference sign 9 indicates a friction plate that is inserted between the shaft main body 21 of the shaft member 2 and the flange 31 of the bracket 3. The friction plate is provided with a non-circular axial hole that has a shape corresponding to that of the axial body 22 of the shaft member 2, and the axial body 22 penetrates through the axial hole. Accordingly, the friction plate 9 integrally rotates with the shaft member 2. This rotation generates friction torque between the friction plate 9 and the bracket 3.

The reference sign 10 indicates a stopper plate that is disposed on the outside of the biasing means 6. The stopper plate 10 is provided with a non-circular axial hole that has a shape corresponding to that of the axial body 22 of the shaft member 2, and the axial body 22 of the shaft member 2 penetrates through that axial hole. Accordingly, the stopper plate 10 integrally rotates with the shaft member 2. The axial body 22 of the shaft member 2 penetrates through the stopper plate 10. A shaft end 22a is clamped inside the axial body 22 so that the leaf springs 61 of the biasing means 6 are bent. This allows the biasing means 6 to bias the cam member 5, the bracket 3, and the friction plate 9 so that they contact each other to generate friction torque due to their sliding against each other. That is to say, the biasing means 6 presses the cam member 5 and the friction plate 9 against the bracket 3 with a load W that is generated by deflecting the leaf springs 61 to a predetermined degree. The rotation of the shaft member 2 under this condition generates friction torque T that allows the second member 120 to be maintained at any specified angle.

As shown in FIGS. 16 and 18, a convex portion 11 is formed on the left and right sides of the axial hole 53 of the cam member 5 so as to sandwich the axial hole 53. The convex portion 11 has an arc-like shape.

As shown in FIGS. 17 and 19 (a), a concave portion 12 of the bracket 3 consists of a lower face part 12a, which forms a lower part, an upper face part 12b, which forms an upper part, and a sloping part 12c, which connects the lower face part 12a and the upper face part 12b. These three parts, the lower face part 12a, sloping part 12c, and upper face part 12b, are integrally formed in the clockwise direction and surround the axial hole 33.

Providing such a difference in height between the lower face part 12a and the upper face part 12b, in relation to the concave portion 12 of the bracket 3, allows the friction torque to vary according to the rotation angle θ of the second member 120. FIG. 19 shows an example of the concave portion 12 that is designed to change the friction torque. The upper face part 12b is set as a benchmark (0 mm), and the lower face part 12a is provided with a depth of 0.4 mm. In this case, if the upper face part 12b and the lower face part 12a are connected by the sloping part 12c, the position of the second member 120 in the axial direction in a contact location 13 in FIG. 19 (a) varies according to the rotation angle θ (see FIG. 19 (b)). A change in that position changes the friction torque T generated between the cam member 5 and the bracket 3.

### PRIOR-ART DOCUMENT

### Patent Document

Patent Document 1: WO2006-35757

Patent Documents 2: Japan Patent No. 4528468

### SUMMARY OF THE INVENTION

### Technical Problems to be Overcome

In the hinge device 1 shown in FIG. 16, the friction torque T varies according to the rotation angle (opening angle) θ of the second member 120.

FIG. 20 shows the friction torque T that varies according to the opening angle θ of the second member 120. When the θ is in the range of 0°-30°, the friction torque T1=100 N·mm. When the θ is in the range of 60°-150°, the friction torque T2=500 N·mm. When the θ is in the range of 30°-60°, the friction torque changes between T1 and T2 according to the opening and closing direction of the second member 120. Also, when the θ is in the range of 30°-60°, the friction torque is assumed to change as shown by the center line in FIG. 20. The larger the difference is between the friction torque of T1 and that of T2, the more difficult it is to accurately ensure the friction torque of both T1 and T2.

The relationship between the friction torque T (N·mm) and the deflection δ (mm) of the leaf springs 61 is shown in FIG. 21, where the friction torque T (N·mm) shown is that generated by using three leaf springs 61 that have the same spring constant as the biasing means 6, as is shown in FIG. 16. Here, the difference in height between the lower face part 12a and the upper face part 12b of the concave portion 12 is set at 0.4 mm.

The friction torque T is calculated using Formula 1, which is T=W·r·μ·2. In Formula 1, W represents a spring load (N), r represents an effective contact radius (mm), and μ represents a friction coefficient, where r is that of the contact location 13 in FIG. 19 and set at 5 mm, and the friction coefficient μ is set at 0.12.

Based on Formula 1, when the friction coefficient T1=100 N·mm, then W=83N, and when the friction coefficient T2=500 N·mm, then W=417N. Accordingly, the total value of the spring constants of the three leaf springs 61 is (417−83)/0.4=835 N·mm, and the value of the spring constant per leaf spring 61 is 2505 N·mm. When the spring constant has such a value, the relationship between the friction torque T and the deflection δ is represented by Line E1 in FIG. 21.

However, a change in the precise shape of the spring or in the physical properties of the spring's material can affect the spring constant. For example, if the spring constant decreases by 10%, and if the spring constant of one leaf spring 61 changes to 2255 N·mm, the relationship between the friction torque T and the deflection δ becomes that shown by Line E2. In this case, in order to set the friction torque T2′ at 500 N·mm, the leaf spring 61 must be deflected to δ=0.55 mm between θ=60°-150°, at which time the friction torque T1′ between θ=0°-30° becomes 140 N·mm, which is 40% higher than the friction torque T1 at 100 N·mm. The larger the difference is between the of T1 and T2, the larger becomes the variation in the friction torque T1 between θ=0°-30°. In order to cope with such a large variation in the friction torque T1, it is possible to use a spring having a large thickness and a large spring constant. However, using such a spring causes a problem in that it is more difficult to accurately ensure the friction torques of both T1 and T2, because the spring constant varies due to changes in the shape, toughness, tensile strength, and the like of the spring.

In contrast, in order that the friction torques T1 and T2 can be set at predetermined values, it is possible to make the difference in height between the lower face part 12a and the upper face part 12b of the concave portion 12 large, and to make the spring constant of the leaf spring 61 small. However, this leads to a piling up of overlapping layers of springs whose individual deflection is small, and this causes a problem in that the hinge device 1 is lengthened axially.

One objective of the present invention is to provide a hinge device that, both before and after a change of friction torque, can accurately ensure the desired friction torque, and that—by eliminating (1) the need for a large difference in height between the convex portion and the concave portion of the bracket 3, and (2) the need for many springs having low deflection in an attempt to accurately ensure the targeted friction torque—the hinge device 1 is not lengthened axially.

### Solution to the Problems

The present invention provides a hinge device for connecting two members, each of which is rotatable with respect to the other, with said hinge device comprising: a bracket that is fixed to one member; a shaft member that is fixed to the other member, the shaft member being supported by the bracket; a cam member that is provided so as to be movable in the axial direction, the rotation of the cam member being restrained by the shaft member; a biasing means that applies a bias to the cam member in the direction toward the place where the cam member contacts the bracket to generate friction torque between the cam member and the bracket; a convex portion formed on the cam member, and a concave portion formed on the bracket, with the convex and concave portions configured so as to be fitted to each other; wherein the convex and concave portions are shaped such that the friction torque varies according to the rotation angle of the shaft member, and the biasing means has an inflection point of a spring constant between the maximum and minimum values of the friction torque.

In the present invention, it is preferable that the biasing means is formed by combining multiple springs, with the spring constant of each spring being different.

Also, the present invention provides a hinge device for connecting two members, each of which is rotatable with respect to the other, with said hinge device comprising: a bracket that is fixed to one member; a shaft member that is fixed to the other member, the shaft member being supported by the bracket; a biasing means that is provided between the shaft member and the bracket so as to be movable in the axial direction, the biasing means contacting the bracket to generate friction torque; a convex portion formed on the biasing means and a concave portion formed on the bracket, with said convex and concave portions being fitted to each other; wherein the convex and concave portions are shaped such that the friction torque varies according to the rotation angle of the shaft member, and the biasing means has an inflection point of a spring constant between the maximum and minimum values of the friction torque.

Also, in the present invention, the biasing means is a spring, whose spring constant varies according to changes of the spring constant.

### Advantageous Effects of the Invention

In the hinge device of the present invention, the biasing means has an inflection point of a spring constant between the maximum and minimum values of the friction torque, which is generated between the cam member and the bracket, so that the friction torque varies according to the rotation of the second member. In response to the variation in the friction torque, the biasing means applies a bias to the cam member and the bracket. Accordingly, the present invention can vary the friction torque accurately. Also, the hinge device provided by the present invention—by eliminating (1) the need to create a difference in height between the convex portion and the concave portion, and (2) the need for many springs of low deflection in an attempt to accurately ensure the targeted friction torque—can be prevented from being lengthened axially.

Also, in the hinge device of the present invention, the biasing means contacts the bracket to generate friction torque. The biasing means has an inflection point of a spring constant between the maximum and minimum values of the friction torque. Therefore, even if the friction torque varies according to the rotation of the second member, the biasing means applies a bias to the bracket in response to the change in the friction torque. Accordingly, the present invention can vary the friction torque accurately. Also, the hinge device provided by the present invention—by eliminating the need to create a difference in height between the convex portion and the concave portion or the need for many springs of low deflection in an attempt to accurately ensure the targeted friction torque—can be prevented from being lengthened axially.

### BRIEF DESCRIPTIONS OF THE DRAWINGS

FIG. 1 is an exploded perspective view showing the hinge device of the first embodiment of the present invention.

FIG. 2(a) shows a side view, FIG. 2(b) shows a plan view, and FIG. 2(c) shows a front view, respectively, of the hinge device of the first embodiment of the present invention.

FIG. 3(a) shows a right-side view, FIG. 3(b) shows a front view, and FIG. 3(c) shows a left-side view, respectively, of a first spring used in the hinge device.

FIG. 4(a) shows a right-side view, FIG. 4(b) shows a front view, and FIG. 4(c) shows a left-side view, respectively, of a second spring used in the hinge device.

FIG. 5 is a characteristics graph showing the relationship between the opening angle and the friction torque of the second member in the first embodiment.

FIG. 6 is a characteristics graph showing the relationship between the bending of a spring and the friction torque in the first embodiment.

FIG. 7(a) shows a side view, FIG. 7(b) shows a plan view, and FIG. 7(c) shows a front view, respectively, of the hinge device of the second embodiment of the present invention.

FIG. 8 is a side view of a bracket in the second embodiment.

FIG. 9 is a characteristics graph showing the relationship between the opening angle and the friction torque of the second member in the second embodiment.

FIG. 10 is a characteristics graph showing the relationship between the bending of a spring and the friction torque in the second embodiment.

FIG. 11(a) shows a plan view, FIG. 11(b) shows a front view, and FIG. 11(c) shows a left-side view, respectively, of the hinge device of the third embodiment of the present invention, in which the second member is at an angle of 0°.

FIG. 12(a) shows a plan view, FIG. 12(b) shows a front view, and FIG. 12(c) shows a left-side view, respectively, of the hinge device of the third embodiment of the present invention, in which the second member is at an angle of 90°.

FIG. 13 is a perspective view showing the spring of the hinge device in the third embodiment.

FIG. 14 is a perspective view showing a notebook computer in which the hinge device is used.

FIG. 15 is a side view illustrating the required characteristics of the hinge device.

FIG. 16(a) shows a side view, FIG. 16(b) shows a plan view, and FIG. 16(c) shows a front view, respectively, of a prior-art hinge device.

FIG. 17(a) shows a front view, FIG. 17(b) shows a plan view, and FIG. 17(c) shows a side view, respectively, of a bracket used in the hinge device.

FIG. 18(a) shows a plan view, FIG. 18(b) shows a side view, and FIG. 18(c) shows a front view, respectively, of a cam member used in the hinge device.

FIG. 19(a) is a side view showing the concave portion provided to the bracket, and FIG. 19(b) is a characteristics graph showing the relationship between the depth of the concave portion and the opening angle of the second member.

FIG. 20 is a characteristics graph showing the relationship between the opening angle of the second member and the friction torque in the prior-art hinge device.

FIG. 21 is a characteristics graph showing the relationship between the deflection of a spring and the friction torque in the prior-art hinge device.

### DESCRIPTIONS OF EMBODIMENTS OF THE INVENTION

Hereinafter, the hinge device according to the exemplary embodiments of the present invention is explained with reference to the accompanying drawings. It should be noted that, in the respective embodiments of the present invention, the members that are the same in the prior-art hinge device are designated with the same reference signs as those of the prior-art hinge device.

### First Embodiment

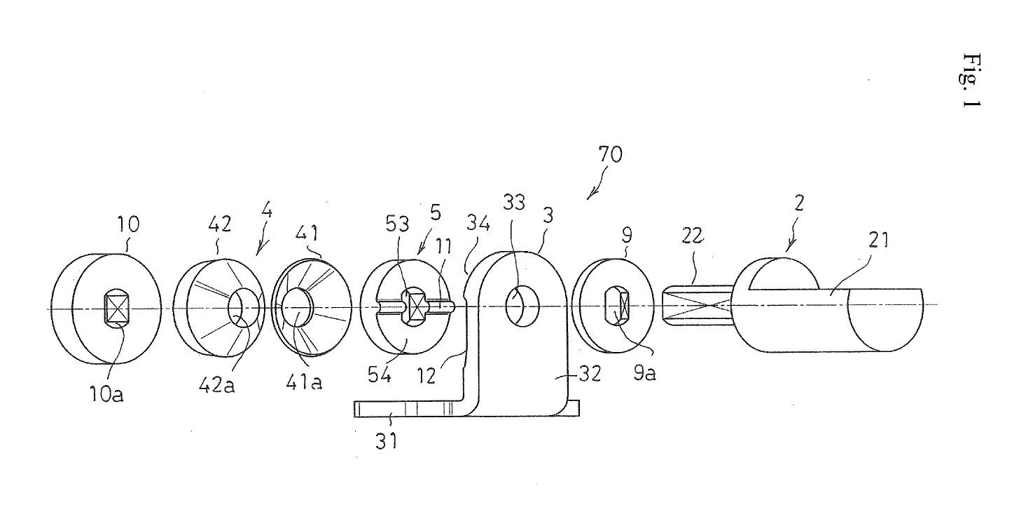

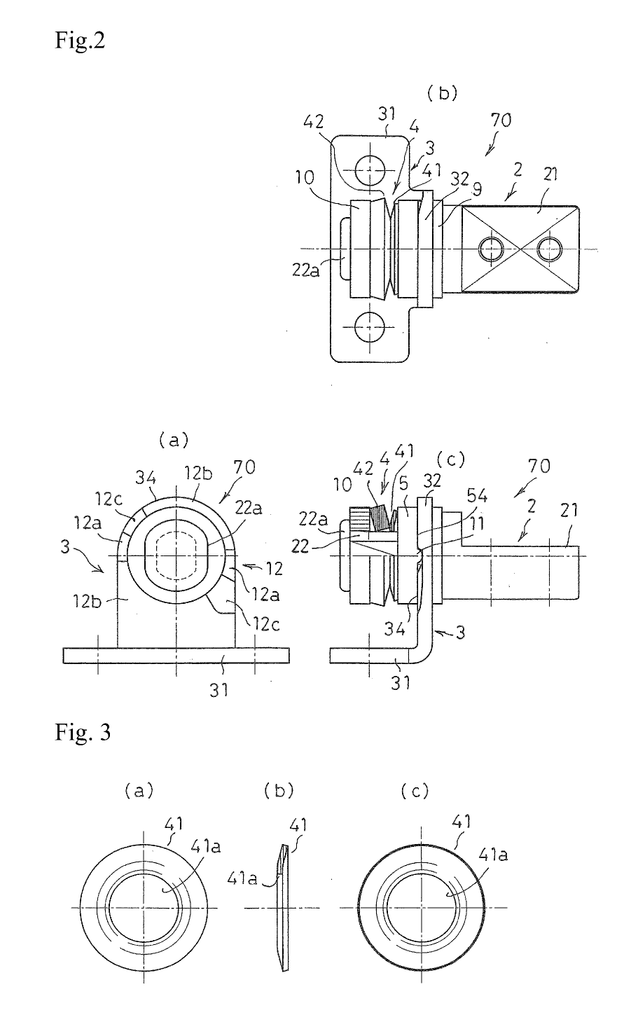

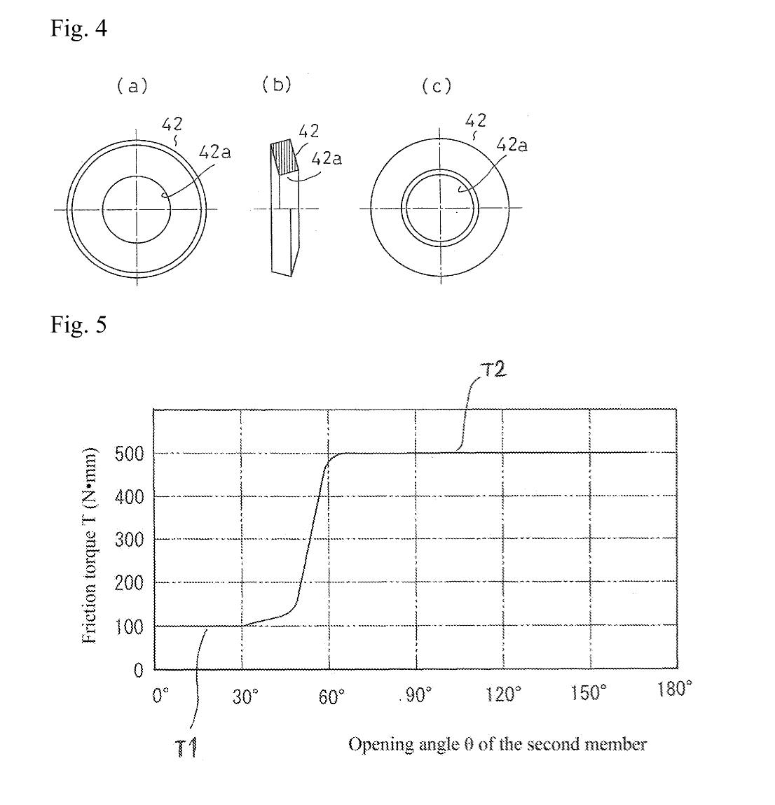

FIGS. 1-6 illustrate the hinge device and its characteristics according to the first embodiment of the present invention. FIG. 1 is an exploded perspective view of the hinge device, FIG. 2 shows the hinge device after being assembled, and FIGS. 3 and 4 show a spring used in the hinge device.

As shown in FIGS. 1-2, the hinge device 70 includes a shaft member 2, a friction plate 9, a bracket 3, a cam member 5, a biasing means 4, and a stopper plate 10.

The shaft member 2, the friction plate 9, the cam member 5, and the stopper plate 10 are similar to those used in the hinge device 1 shown in FIG. 16. That is, the shaft member 2 is formed of the shaft main body 21 and the axial body 22, which extends from one side of the shaft main body 21 and that has a non-circular shape. The shaft member 2 is fixed to the second member 120 by the screw 7 in the same manner as in FIG. 16, and the shaft member 2 integrally rotates with the second member 120.

The friction plate 9 is disposed between the shaft main body 21 and the bracket 3. The friction plate 9 is provided with a non-circular axial hole 9a that has a shape corresponding to that of the axial body 22. The shaft member 2 penetrates through the axial hole 9a, so that the friction plate 9 integrally rotates with the shaft member 2

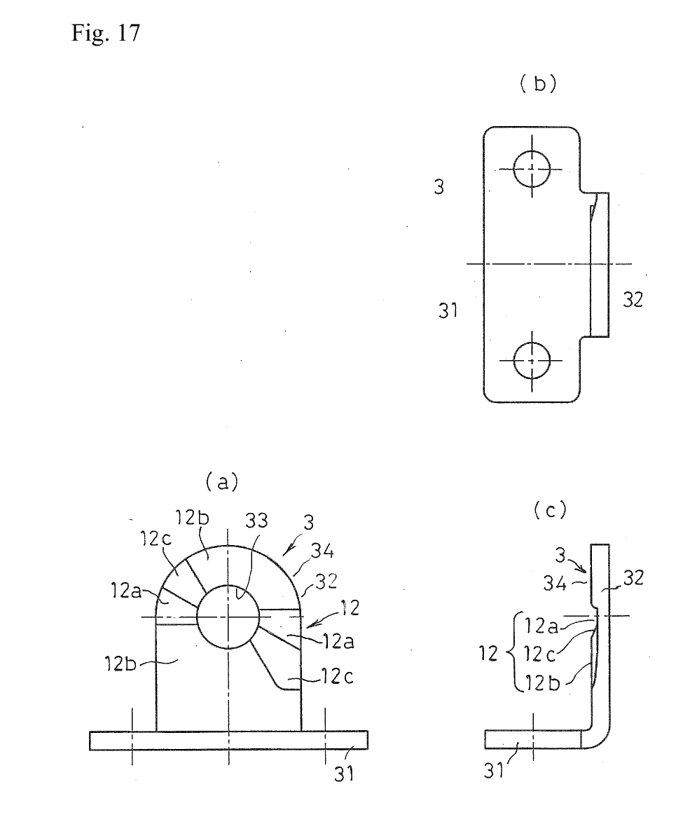

The bracket 3 has a flange 31 and a bearing 32. As is shown in FIG. 16, the flange 31 is fixed to the first member 110 by a screw 8 so as to be one part of an immobilized member. The bearing 32 is provided with a round axial hole 33 through which the axial body 22 of the shaft member 2 penetrates, whereby the bracket 3 rotatably supports the shaft member 2. A friction surface 34—which faces the cam member 5—on the bearing 32 of the bracket 3 is provided with a concave portion 12. The concave portion 12 consists of a lower face part 12a, a sloping part 12c, and an upper face part 12b. These three parts are formed integrally in the clockwise direction and surround the axial hole 33 in the same manner as shown in FIG. 17.

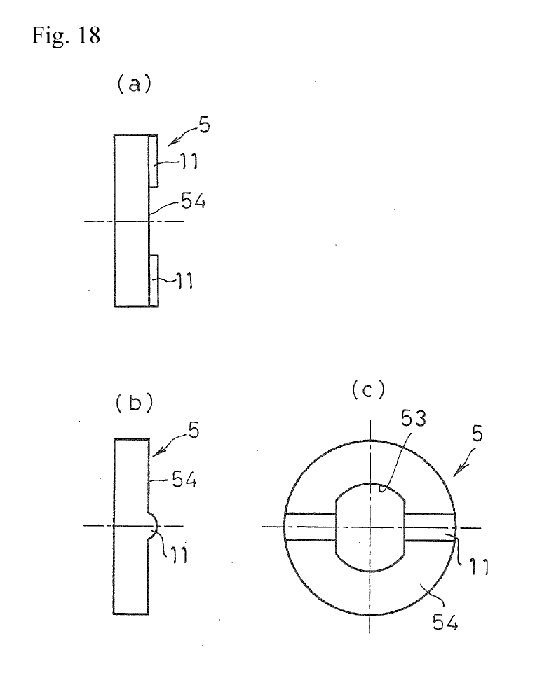

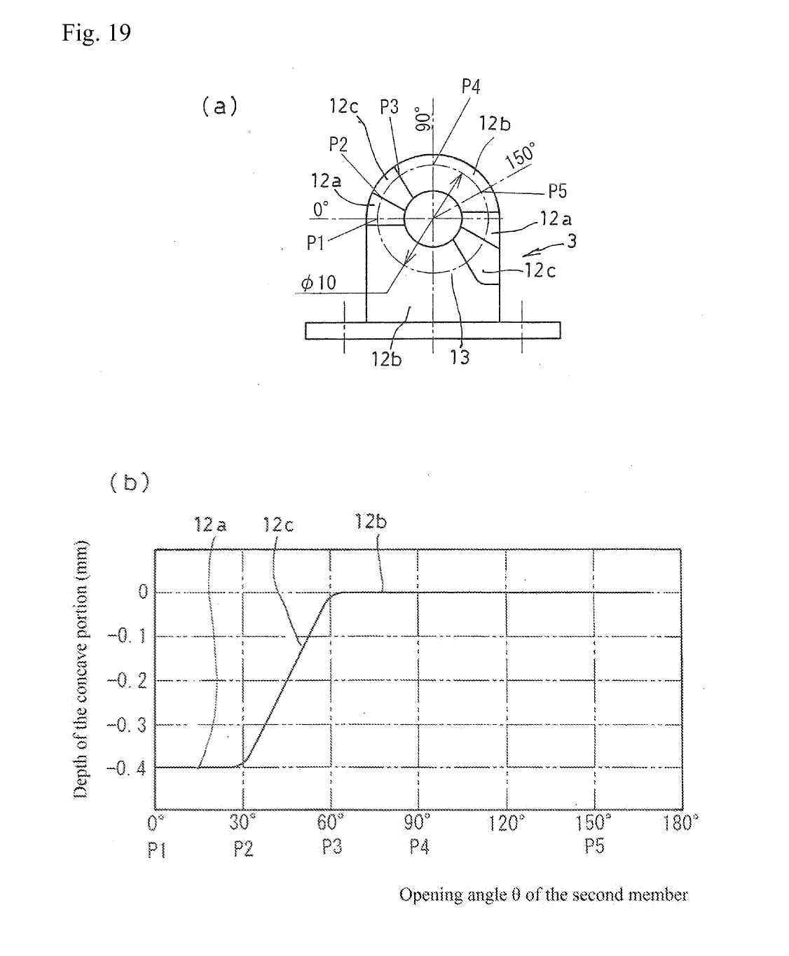

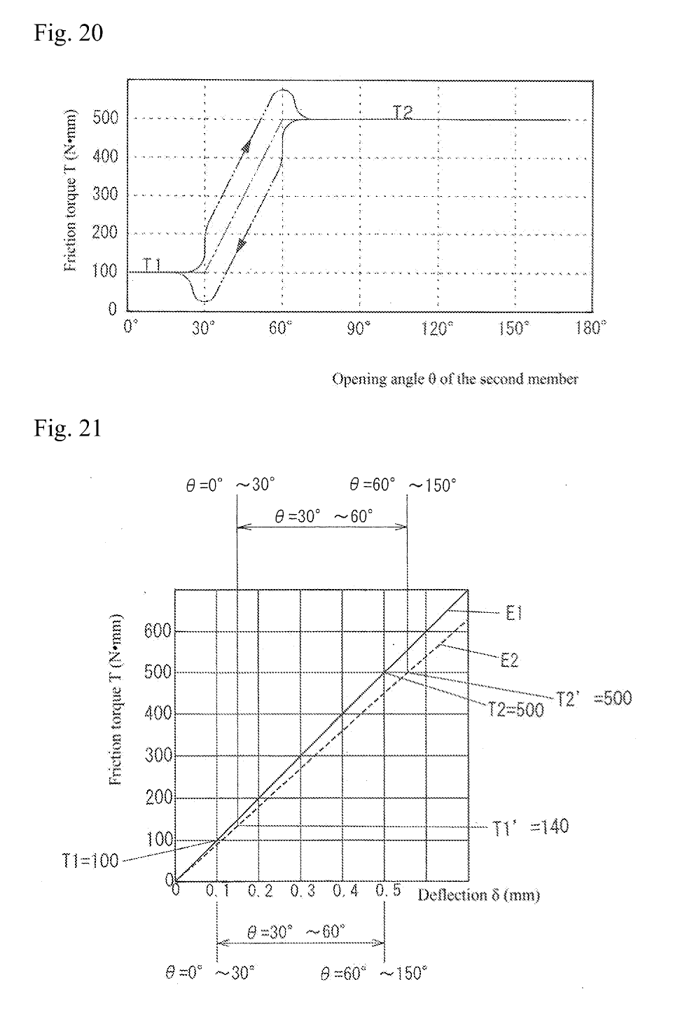

The cam member 5 has a circular shape and is provided with a non-circular axial hole 53 that has a shape corresponding to that of the axial body 22 of the shaft member 2. The axial body 22 penetrates through the axial hole 53. This allows the cam member 5 to integrally rotate with the shaft member 2, by which the cam member 5 slides on the bracket 3, thereby generating friction torque between the cam member 5 and the bracket 3. The friction surface 54 of the cam member 5 is provided with a convex portion 11 that has an arc-like shape, in the same manner as shown in FIG. 18. The convex portion 11 is formed on the left and right sides of the axial hole 53, sandwiching the axial hole 53.

The stopper plate 10 is provided with a non-circular axial hole 10a that has a shape corresponding to that of the axial body 22 of the shaft member 2, and the axial body 22 of the shaft member 2 penetrates through the axial hole 10a, whereby the stopper plate 10 integrally rotates with the shaft member 2. The axial body 22 of the shaft member 2 penetrates through the stopper plate 10, and one shaft end 22a (see FIG. 2) is clamped so that the biasing means 4 is deflected. This allows the biasing means 4 to apply a bias to the cam member 5, the bracket 3, and the friction plate 9 so that they contact each other to generate friction torque due to their sliding against each other. This friction torque allows the second member 120 to be maintained at any specified angle, by which the second member 120 is held at any arbitrary angle.

The biasing means 4 is disposed between the cam member 5 and the stopper plate 10. In this embodiment, the biasing means 4 uses two round-shaped disc springs 41 and 42 (a first spring 41 and a second spring 42). Disc springs 41 and 42 are respectively provided with circular axial holes 41a and 42a, through which the axial body 22 of the shaft member 2 penetrates.

In the hinge device 70 having the aforesaid structure, the bracket 3 is one part of the immobilized member, and the friction plate 9, the cam member 5, and the stopper plate 10 synchronously rotate with the shaft member 2 in the rotational direction of the shaft member 2.

In this embodiment, the thickness of the first spring 41 constituting the biasing means 4 is thin as shown in FIG. 3, and therefore the spring constant thereof is small, allowing the first spring 41 to bend largely. In contrast, the thickness of the second spring 42 is thick as shown in FIG. 4, and therefore the spring constant thereof is large, so that the second spring 42 is a spring that has low bending capability and that can cope with a high load. The biasing means 4 is formed by laying, one upon the other, such two springs 41 and 42 that have different spring constants.

In this embodiment of the hinge device 70, the convex portion 11 of the cam member 5 is set such that (1) while the rotation angle (opening angle) θ of the second member 120 is in the range of 0°-30°, the convex portion 11 of the cam member 5 slides on the lower face part 12a of the concave portion 12 of the bracket 3; (2) while the rotation angle (opening angle) θ of the second member 120 is in the range of 30°-60°, the convex portion 11 of the cam member 5 slides on the sloping part 12c; and (3) while the rotation angle (opening angle) θ of the second member 120 is in the range of 60°-150°, the convex portion 11 of the cam member 5 slides on the upper face part 12b. FIG. 5 is a characteristics diagram that shows the changes of the friction torque T relative to the changes of the opening angle θ of the second member 120 in such a setting of the convex portion 11 of the cam member 5. The friction torque T changes in the range from T1=100 N·mm to T2=500 N·mm.

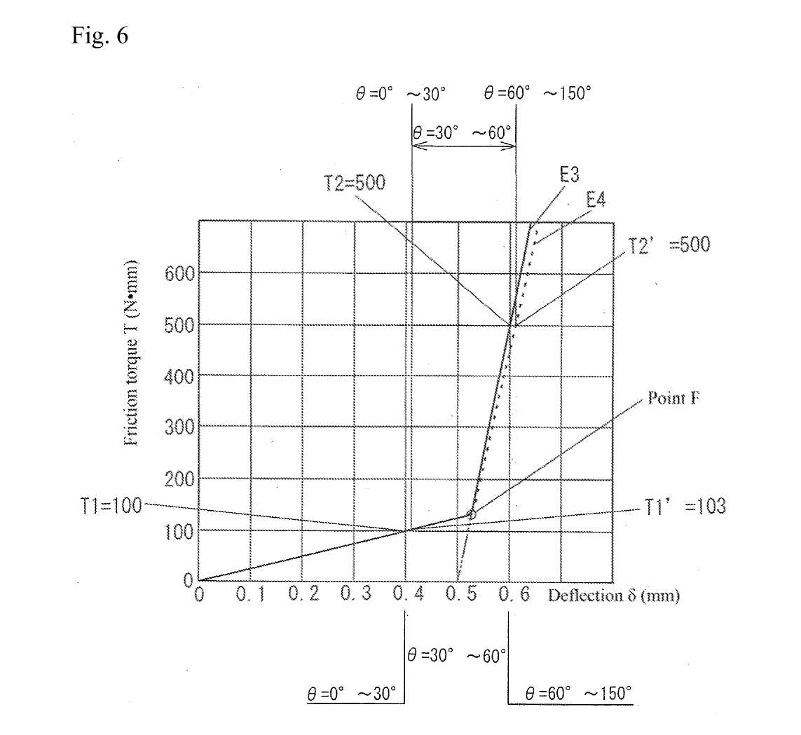

FIG. 6 is a characteristics diagram that shows the relationship between the bending δ of the springs 41 and 42 of the biasing means 4 and the friction torque T in this embodiment, where the friction torque T changes along the line E3, which is expressed by a solid line. On the line E3, when the opening angle θ of the second member 120 is in the range of 0°-30°, the friction torque T1 is 100N·mm, where the first spring 41 bends into the state just before the first spring 41 closely contacts the cam member 5. While the θ changes from 30° to 60°, the convex portion 11 slides on the sloping part 12c of the concave portion 12 of the cam member 5, and therefore the cam member 5 moves in the axial direction of the shaft member 2, which movement allows the first spring 41 to be in close contact with the bracket 3 at the point F. When the second member 120 further rotates and the θ further changes so that the point on the line E corresponding to the θ further moves up the line E, the second spring 42 bends so as to work as a spring. While the opening angle θ changes from 60°-150°, the convex portion 11 slides on the upper face part 12b, and the second spring 42 bends to generate the friction torque T2 of 500 N·mm.

FIG. 6 is a characteristics diagram that shows the relationship between the bending δ of the biasing means 4 and the friction torque T in this embodiment, in which the friction torque T is calculated based on the above Formula 1. When the friction torque T2 is 500 N·mm, the spring load W is 417N, and the spring constant Ka of the second spring 42 is Ka=417 N/0.1 mm=4170 N·mm. In contrast, when the friction torque T1 is 100 N·mm, the spring load is 83N, at which time the spring constant K(a+b) resulting from adding up the spring load of the first spring 41 and that of the second spring 42 is 83N/0.4 mm=208N·mm. Since K(a+b)=K(a)·K(b)/(Ka+Kb), the spring constant Kb of the first spring 41 is 219N·mm.

In the above instance, if the spring constant of the second spring 42 is 3753 N·mm, which is 10% lower than 4170 N·mm, the line E3 changes to the line E4 in FIG. 6. The friction torque T1′ on the line E4 is 103N·mm, which is about 3% more than the friction torque T1. This increase is significantly lower than the 40% of the prior-art hinge device 1 shown in FIG. 16. This means that the hinge device of the present invention can accurately ensures changing friction torque.

Also, the prior-art hinge device 1 in FIG. 16 requires three pieces of the spring 61, but in this embodiment of the present invention, only two pieces—springs 41 and 42—can serve the required function of the device, because the first spring 41 bends greatly. In addition, in the prior-art hinge device 1, the concave portion 12 requires a depth of 0.4 mm, but in this embodiment, a depth of 0.2 mm can serve the required function of the device. The reduction of the depth allows the concave portion 12 and the convex portion 11 corresponding thereto to be small. Due to these features, the hinge device 70 of this embodiment can be axially short.

In this embodiment, while the friction torque T takes the maximum value (T2=500 N·mm) and the minimum value (T1=100 N·mm), there is a point F where the first spring 41 closely contacts the bracket 3, which is the inflection point of the spring constant. That is, the biasing means 4, consisting of the first spring 41 and the second spring 42, has an inflection point of the spring constant, where the spring that deflects is changed from the first spring 41 to the second spring 42, between the maximum value T2 and the minimum value T1. Accordingly, even if the friction torque varies according to the rotation of the second member 120, the biasing means 4 applies to the cam member 5 and the bracket 3 a bias corresponding to this change in the friction torque. Therefore, the friction torque can be accurately changed. Also, it is not necessary—in order to cope with the increased difference in height so as to accurately ensure the predetermined friction torque—to increase the difference in height between the convex portion 11 and the concave portion 12 or to lay many springs having only low bending capability. Therefore, the hinge device according to this embodiment can be prevented from being lengthened axially.

### Second Embodiment

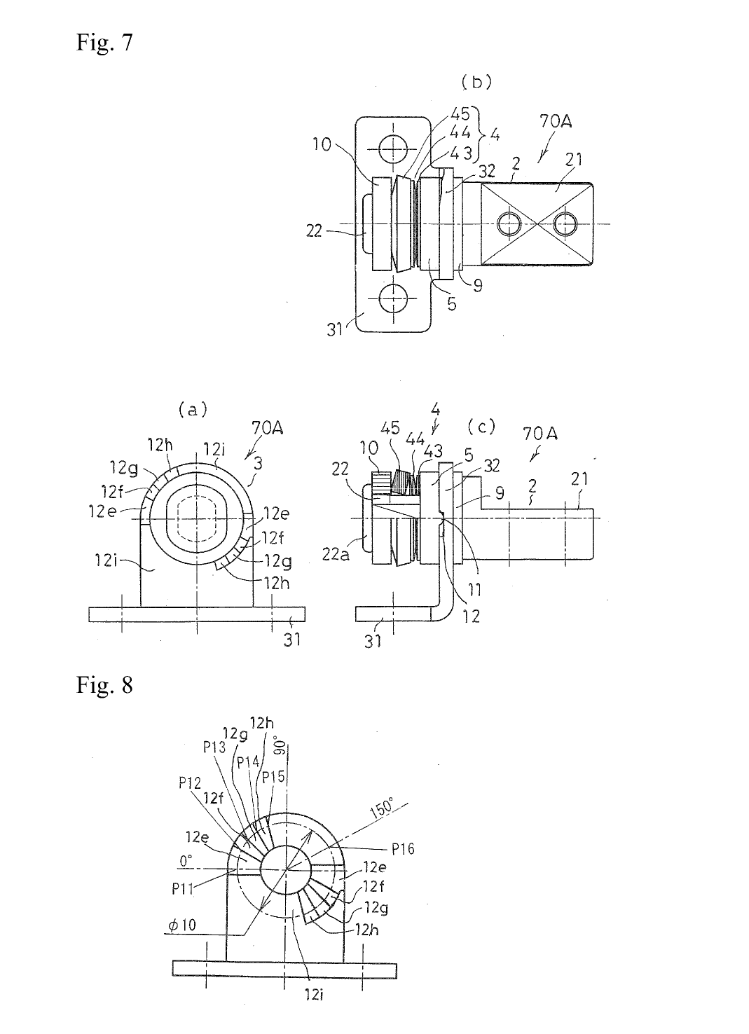

FIGS. 7(a)-7(c) and FIGS. 8-10 show the hinge device 70A according to the second embodiment. In this embodiment, the concave portion 12 formed on the bracket 3 and the biasing means 4 are different from those of the hinge device 70 of the first embodiment. Other members of the hinge device 70A of this embodiment are the same as those of the hinge device 70 of the first embodiment.

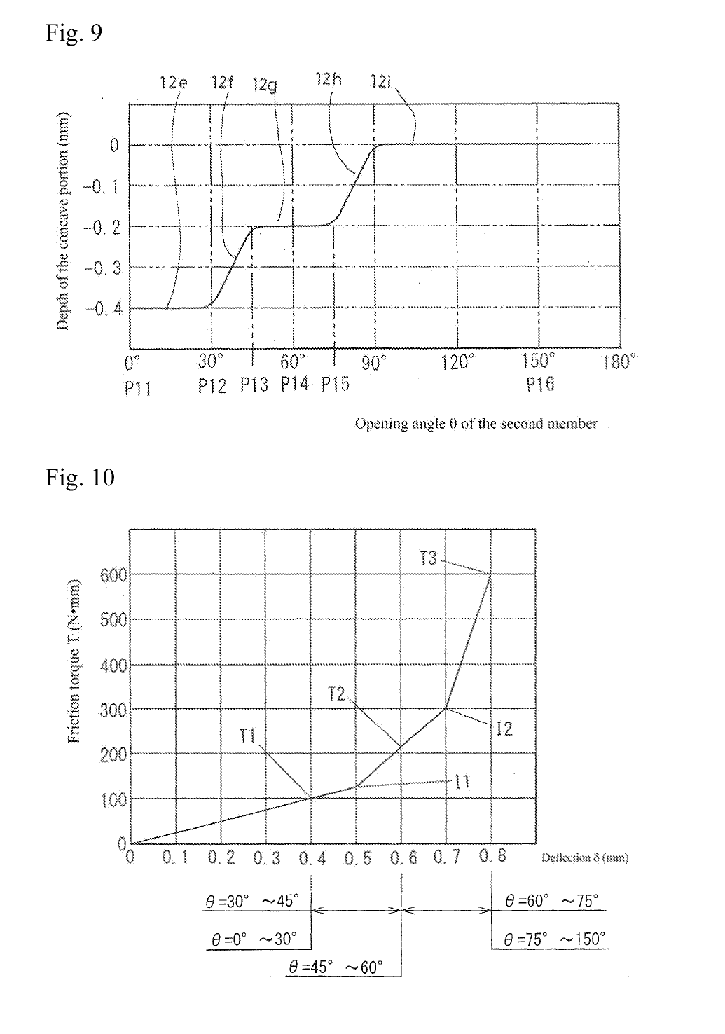

FIGS. 8 and 9 show the concave portion 12 formed on the bracket 3, in which a lower face part 12e, a first sloping part 12f, a middle face part 12g, a second sloping part 12h, and an upper face part 12i are integrally formed in a clockwise direction and surround the axial hole 33. These faces 12e, 12f, 12g, 12h, and 12i are divided by lines P12, P13, P14, and P15, respectively. If the upper face part 12i is set as a benchmark (0 mm), the middle face part 12g is provided with the depth of 0.2 mm, and the lower face part 12e is provided with the depth of 0.4 mm.

The biasing means 4 is formed by three disc springs—a first spring 43, a second spring 44, and a third spring 45—as shown in FIG. 7. These springs 43, 44, and 45 are sandwiched between a cam member 5 and a stopper plate 10. The thickness of the respective springs become larger in the ascending order of the first spring 43, the second spring 44, and the third spring 45, and accordingly the spring constant of the first spring 43 is the smallest of the three springs, larger at the second spring 44, and largest at the third spring 45. Therefore, the deflection is largest at the first spring 43, smaller at the second spring 44, and smallest at the third spring 45.

FIG. 10 shows the relationship between the deflection δ and the friction torque T in the biasing means 4 according to this embodiment. As the convex portion 11 of the cam member 5 successively slides on the lower face part 12e, the first sloping part 12f, the middle face part 12g, the second sloping part 12h, and the upper face part 12i, the friction torque T changes from 100 N·mm to 600 N·mm. In this embodiment, the first spring 43 closely contacts the cam member 5 at the inflection point I1 between friction torques T1 and T2, the second spring 44 closely contacts the cam member 5 at the inflection point I2 between the friction torques T2 and T3, and then only the third spring 45 deflects so as to generate friction torque.

Also, in this embodiment, the biasing means 4 is formed by laying one upon the other, three springs 43, 44, and 45, each of which has a different constant, in which the friction torque T generated by the deflection of the springs inflects at the inflection points I1 and I2 of the spring constant of the springs 43 and 44 between the maximum value (T2=600 N/m) and the minimum value (T1=100 N/m). Therefore, even if friction torque changes due to the rotation of the second member 120, the biasing means 4 applies a bias to the cam member 5 and to the bracket 3 in response to the change of the friction torque. Accordingly, the friction torque can be accurately changed. Also, it is not necessary to increase the difference in height between the convex portion 11 and the concave portion 12, or to lay many springs of low deflection so as to cope with the increased difference in height, so as to accurately ensure the predetermined friction torque. Therefore, the hinge device according to this embodiment can be prevented from being lengthened axially.

### Third Embodiment

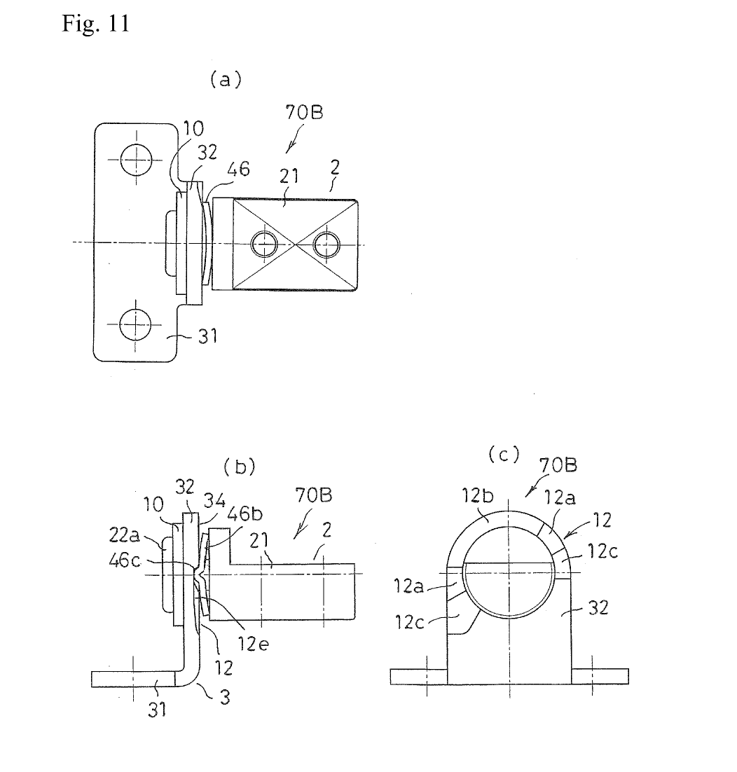

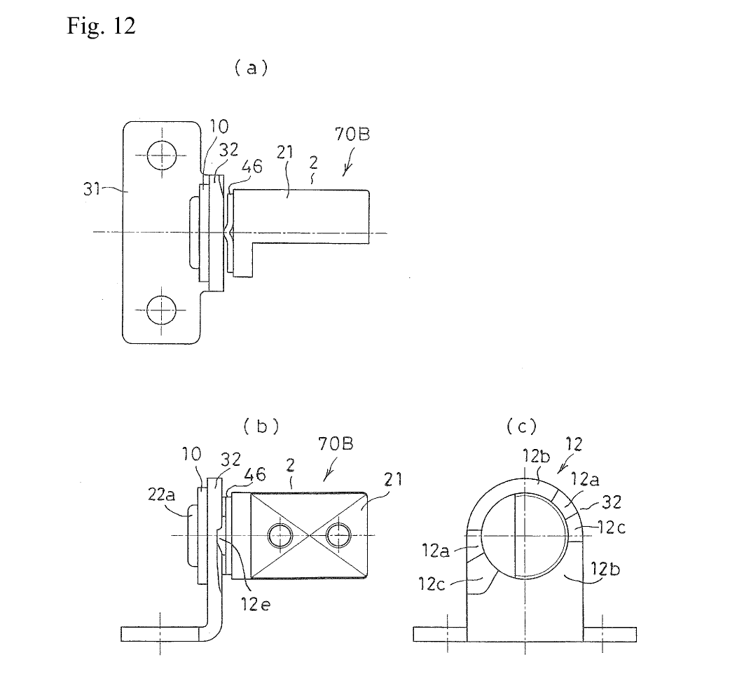

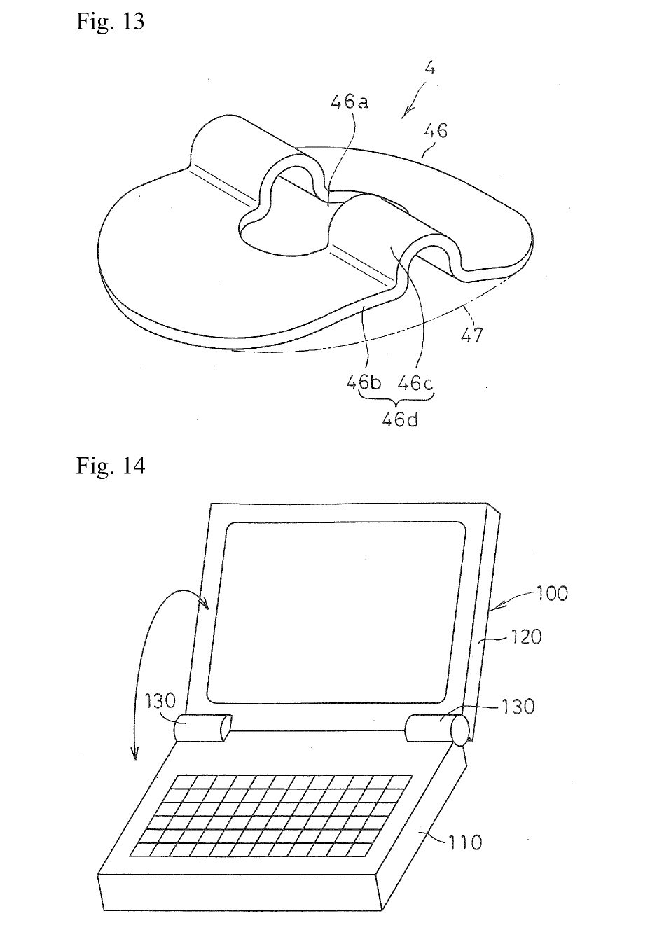

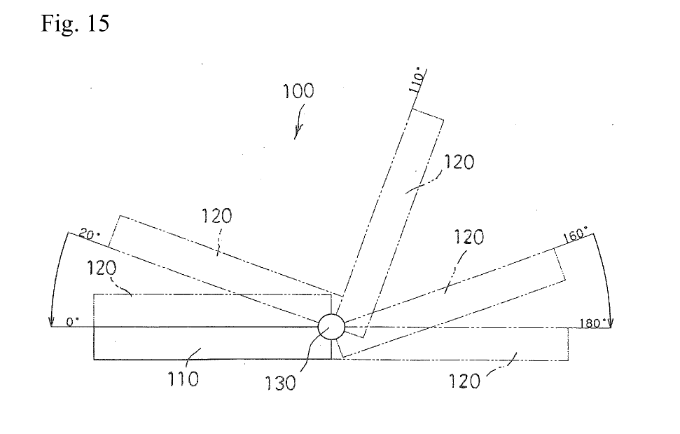

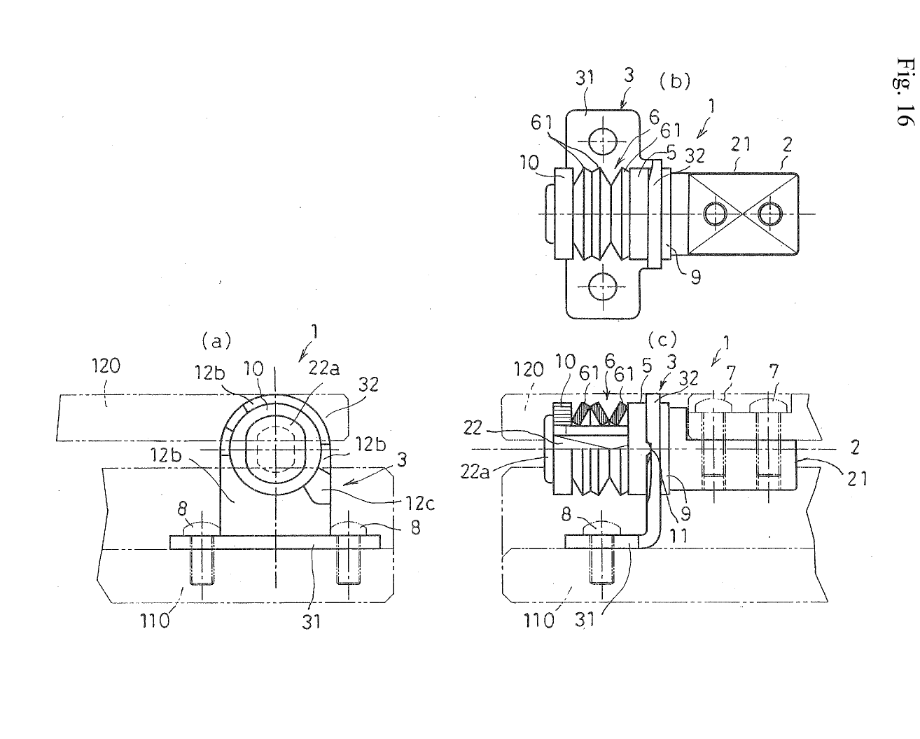

FIGS. 11(a)-11(c) and FIGS. 12-13 show the hinge device 70B according to the third embodiment of the present invention. FIGS. 11(a)-11(c) show the state where the opening angle θ of the second member 120 is 0°, and FIGS. 12(a)-12(c) show the state where the opening angle θ of the second member 120 is 90°. In the hinge device 70B of this embodiment, a deformed leaf spring 46 is used as a biasing means 4, as shown in FIG. 13. Other members of the hinge device 70B of this embodiment are the same as those of the hinge device 70 of the first embodiment. Accordingly, on a bearing 32 of a bracket 3, a lower face part 12a, a sloping part 12c, and an upper face part 12b are continuously formed in the counterclockwise direction so as to surround the axial hole 33. In addition, the deformed leaf spring 46 is sandwiched between the shaft main body 21 of a shaft member 2 and a friction surface 34, where the concave portion 12 of the bracket 3 is formed. Accordingly, in this embodiment, friction torque is generated by the biasing means 4 being in contact with the bearing 32 of the bracket 3, and therefore a cam member 5 is unnecessary.

The deformed leaf spring 46 is provided with a convex portion 46d so as to be formed wholly on the spring 46 and so that the convex portion 46d protrudes towards the concave portion 12 of the bracket 3. The convex portion 46d is formed by a raised portion 46b, which rises in an oblique direction facing the plane having a periphery 47, and an arcuate portion 46c formed higher than the raised portion 46b. The arcuate portion 46c is formed on the left and right sides of a bearing's through-hole 46a so as to sandwich that hole. The raised portion 46b and the arcuate portion 46c are set to be capable of deflecting, and the arcuate portion 46c has a smaller curvature than the raised portion 46b, so that the arcuate portion 46c is less likely to deflect than is the raised portion 46b. Accordingly, the spring constant of the raised portion 46b is lower than that of the arcuate portion 46c. A deformed spring 46 like this can be used as a biasing means 4, whose spring constant changes.

In this embodiment, the deformed leaf spring 46 works as follows. When the opening angle θ of the second member 120 is in the range of 0°-30°, the raised portion 46b works as a spring whose spring constant is small, so that the friction torque T1 is generated. If the θ changes from 30° to 60°, the raised portion 46b closely contacts the shaft member 2, where the spring constant reaches an inflection point. When the raised portion 46b closely contacts the shaft member 2, only the arcuate portion 46c works as a spring, by which the spring constant increases, so that friction torque T2 is generated.

In this embodiment, using only one deformed leaf spring 46 as a biasing means 4 can change the friction torque in response to the rotation of the second member 120, so that the hinge device can accurately ensure the friction torque. Also, it is not necessary to increase the difference in height between the convex portion 11 and the concave portion 12, or to lay, one upon the other, many springs of low deflection so as to cope with the increased difference in height, and therefore the hinge device according to this embodiment can be prevented from being lengthened axially.

While this invention has been shown and described with respect to particular embodiments thereof, this is for the purpose of illustration rather than limitation, and other variations and modifications of the specific embodiments shown and described herein would be obvious to a person skilled in the art. For example, the convex portion 11 can be formed on the bracket 3, and the concave portion 12 can be formed on the cam member 5. Also, the setting of the angle of the concave portion 12 can be changed as deemed appropriate.

### LIST OF REFERENCE SIGNS

2 shaft member
3 bracket
4 biasing means
5 cam member
6 biasing means
11 convex portion of the bracket 3
12 concave portion of the bracket 3
41, 43 first spring
42, 44 second spring
45 third spring
46 deformed leaf spring
46d convex portion of the bracket 3
70, 70A, 70B hinge device

1. A hinge device for connecting two members, each of which is rotatable with respect to each other, said hinge device comprising:
a bracket that is fixed to one of said members;
a shaft member that is fixed to the other member and supported by the bracket;
a cam member that is provided so as to be movable in the axial direction, the rotation of the cam member being restrained by the shaft member;
a biasing means that applies a bias to the cam member in the direction toward the place where the cam member is in contact with the bracket, so as to generate friction torque between the cam member and the bracket;
a convex portion formed on the cam member and a concave portion formed on the bracket, with said convex and concave portions configured so as to be fitted to each other;
wherein said convex and concave portions are shaped such that the friction torque varies according to the rotation angle of the shaft member, and
the biasing means has an inflection point of a spring constant between the maximum and minimum values of the friction torque.

2. The hinge device according to claim 1, wherein the biasing means is formed by combining multiple springs, with each spring having a different spring constant.

3. A hinge device for connecting two members, each of which is rotatable with respect to each other, said hinge device comprising:
a bracket that is fixed to one of said members;
a shaft member that is fixed to the other member and that is supported by the bracket;
a biasing means that is provided between the shaft member and the bracket so as to be movable in the axial direction, the biasing means making contact with the bracket to generate friction torque;
a convex portion formed on the biasing means and a concave portion formed on the bracket, with said convex and concave portions being fitted to each other;
wherein said convex and concave portions are shaped such that the friction torque varies according to the rotation angle of the shaft member, and
the biasing means has an inflection point of a spring constant between the maximum and minimum values of the friction torque.

4. The hinge device according to claim 3, wherein the biasing means is a spring, whose spring constant changes in accordance with changes of the spring constant.
